(19) United States
(12) Patent Application Publication
(10) Pub. No.: US 2008/0235306 A1
(43) Pub. Date: Sep. 25, 2008

(54) GARBAGE COLLECTION IN NONVOLATILE MEMORIES USING DATA ATTRIBUTES, COMPUTER PROGRAM PRODUCTS AND METHODS OF OPERATING THE SAME

(75) Inventors: Jeong-Eun Kim, Gyeonggi-do (KR); Nam-Yoon Woo, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 12/051,598

(22) Filed: Mar. 19, 2008

(30) Foreign Application Priority Data
Mar. 20, 2007 (KR) 10-2007-0027302

(51) Int. Cl. G06F 17/30

(52) U.S. Cl. 707/206; 707/E17.005

(57) ABSTRACT

A garbage collection apparatus of a nonvolatile memory can include a first-block management module that is configured to manage a plurality of first blocks, where each of the first blocks includes at least one respective invalid page of the nonvolatile memory. A second-block management module is configured to manage a plurality of second blocks to be allocated for storing data and/or metadata in the nonvolatile memory and is further configured to perform garbage collection for the nonvolatile memory. A control module is configured to allocate ones of the second blocks to respective ones of the first blocks according to when the at least one respective invalid page in each of the first blocks was generated or used.

### CROSS-REFERENCE TO RELATED APPLICATION

This application claims priority from Korean Patent Application No. 10-2007-0027302 filed on Mar. 20, 2007 in the Korean Intellectual Property Office, the disclosure of which is incorporated herein by reference in its entirety.

### FIELD OF THE INVENTION

The present invention relates to the field of semiconductors in general, and more particularly, to garbage collection circuits in non-volatile memories.

### BACKGROUND

Nonvolatile memories have been widely used in various embedded systems such as home electronic devices, communication devices and set-top boxes as storage media for storing and processing data.

Nonvolatile memories can provide not only the advantages of random access memories (RAMs) from/to which data can be freely erased/written but also the advantages of read only memories (ROMs) which can store data even when power is cut off.

Flash memories are one of the most widely-used nonvolatile memories, which are suitable for use in portable devices since they consume less power than magnetic disc memory-based storage media, provide fast access speed as hard discs, and are small in size.

When the data stored in a nonvolatile memory is updated with new data, the page written with the original data is considered to be invalid, and a new page is allocated so that the new data can be written on the new page. However, if the nonvolatile memory has insufficient available storage space to store the new data, the available storage space of the nonvolatile memory may be increased by performing garbage collection so that only the valid pages can be collected.

Conventionally, garbage collection is performed by generating and managing a block list including blocks having one or more invalid pages and a block list including garbage blocks having invalid pages only. In this manner, a shortage of blocks to be allocated for garbage collection can be addressed, and the number of blocks having invalid pages can be reduced.

FIG. 1 illustrates a block list including blocks having invalid pages, and FIG. 2 illustrates a block list including blocks to be allocated for conventional garbage collection. Referring to FIGS. 1 and 2, garbage collection is performed on a block having the greatest number of invalid pages, i.e., block #80 (11), by selecting a block that has been erased the least number of times, e.g., block #15 (12), from a block list for managing a plurality of blocks to be allocated for garbage collection, and then allocating block #15 (12) to block #80 (11) so that valid pages of block #80 (11) can be copied to block #15 (12).

In the conventional garbage collection method illustrated in FIGS. 1 and 2, a block that has been erased the least number of times is allocated to perform garbage collection in order to properly perform wear leveling and to reduce the occurrence of bad blocks.

Japanese Patent Laid-Open Gazette No. 2002-278828 discloses a method of reducing the time required for garbage collection in which garbage collection is performed more frequently on a first memory zone storing data only for a short period of time than on a second memory zone storing data for a longer period of time.

### SUMMARY

Embodiments according to the present invention can provide garbage collection in nonvolatile memories using data attributes, computer program products and methods of operating the same. Pursuant to these embodiments, a garbage collection apparatus of a nonvolatile memory can include a first-block management module that is configured to manage a plurality of first blocks, where each of the first blocks includes at least one respective invalid page of the nonvolatile memory. A second-block management module is configured to manage a plurality of second blocks to be allocated for storing data and/or metadata in the nonvolatile memory and is further configured to perform garbage collection for the nonvolatile memory. A control module is configured to allocate ones of the second blocks to respective ones of the first blocks according to when the at least one respective invalid page in each of the first blocks was generated or used.

### BRIEF DESCRIPTION OF THE DRAWINGS

The above and other aspects and features of the present invention will become more apparent by describing in detail exemplary embodiments thereof with reference to the attached drawings, in which:

FIG. 1 illustrates a block list including blocks having invalid pages;

FIG. 2 illustrates a block list including blocks to be allocated for conventional garbage collection;

FIG. 3 illustrates a block diagram of a garbage collection apparatus of a nonvolatile memory, according to an embodiment of the present invention;

FIG. 4 illustrates a first block list according to an embodiment of the present invention;

FIG. 5 illustrates how to update the first block list illustrated in FIG. 4 upon detection of a new invalid page from a block not included in the first block list illustrated in FIG. 4;

FIGS. 6 and 7 illustrate how to update the first block list illustrated in FIG. 4 upon detection of a new invalid page from a block included in the first block list illustrated in FIG. 4;

FIG. 8 illustrates a second block list according to an embodiment of the present invention;

FIG. 9 illustrates a flowchart of a garbage collection method of a nonvolatile memory according to an embodiment of the present invention; and

FIG. 10 further explains the garbage collection method illustrated in FIG. 9.

### DESCRIPTION OF EMBODIMENTS ACCORDING TO THE INVENTION

The various aspects and features of the present invention and methods of accomplishing the same may be understood more readily by reference to the following detailed description of exemplary preferred embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the present invention to those skilled in the art, and the present invention is defined by the appended claims. Like reference numerals refer to like elements throughout the specification.

The present invention is described hereinafter with reference to flowchart illustrations of user interfaces, methods, and computer program products according to embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be understood that, although the terms first, second, etc. may be used herein to describe various elements, these elements should not be limited by these terms. These terms are only used to distinguish one element from another. Thus, a first element could be termed a second element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The term ‘module’, as used herein, includes, but is not limited to, a software or hardware component, such as a Field Programmable Gate-Array (FPGA) or Application-Specific Integrated Circuit (ASIC), which performs certain tasks. A module may advantageously be configured to reside on an addressable storage medium and be configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

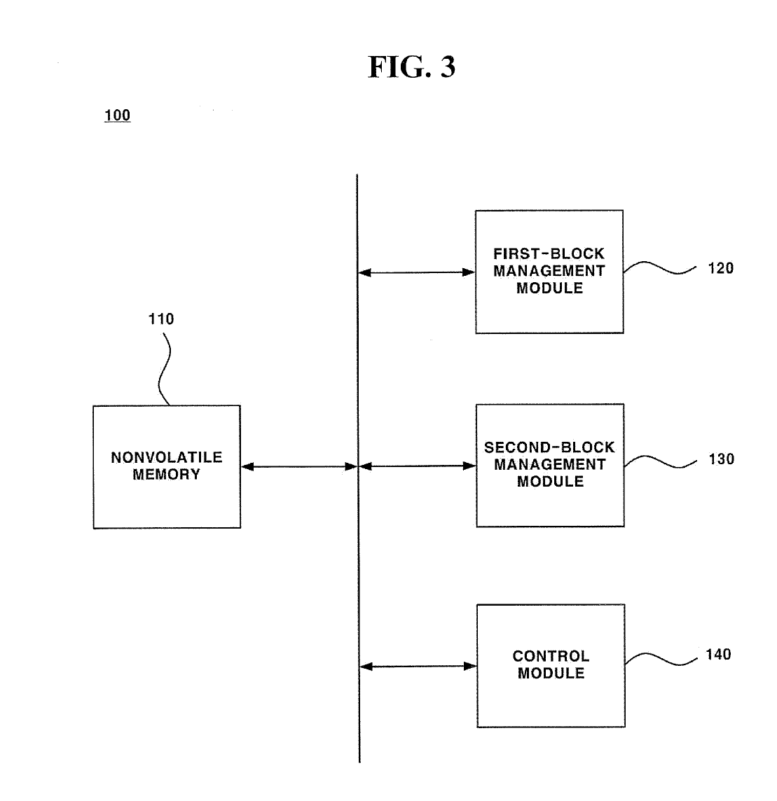

FIG. 3 illustrates a block diagram of a garbage collection apparatus 100 of a nonvolatile memory, according to an embodiment of the present invention. Referring to FIG. 3, the garbage collection apparatus 100 includes a nonvolatile memory 110, a first-block management module 120 which manages a plurality of first blocks of the nonvolatile memory 110, a second-block management module 130 which stores data and metadata and manages a plurality of second blocks to be allocated for storing data and metadata and for performing garbage collection, and a control module 140 which performs garbage collection by allocating the second blocks to the first blocks, respectively, in the order the invalid pages of the first blocks are generated. The first blocks are blocks that include one or more invalid pages, and second blocks are blocks that include invalid pages only.

In this embodiment, the nonvolatile memory 110 is a flash memory.

Flash memories are generally classified into small-block flash memories and large-block flash memories. In the case of small-block flash memories, the size of logical operation units is the same as the size of physical operation units, whereas, in the case of large-block flash memories, the size of physical operation units is larger than the size of logical operation units. In general, logical operation units may be referred to as sectors, and physical operation units may be referred to as pages. A block of a flash memory may include a plurality of pages, and data may be erased from a flash memory in units of blocks. However, the present invention is not restricted to this. That is, the logical operation units and the physical operation units may be labeled differently from those set forth herein.

The first-block management module 120 manages a plurality of blocks of the nonvolatile memory 110. The blocks include at least one invalid page and are thus classified as being first blocks. The nonvolatile memory 110 may include more than one first block.

The first-block management module 120 may generate a first block list in order to manage the first blocks. The first-block management module 120 may arrange the first blocks in the first block list in the order the invalid pages of the first blocks are generated or in the order the first blocks are used. That is, the first-block management module 120 may maintain the first block list in a first-input-first-output (FIFO) manner or a least-recently-used (LRU) manner.

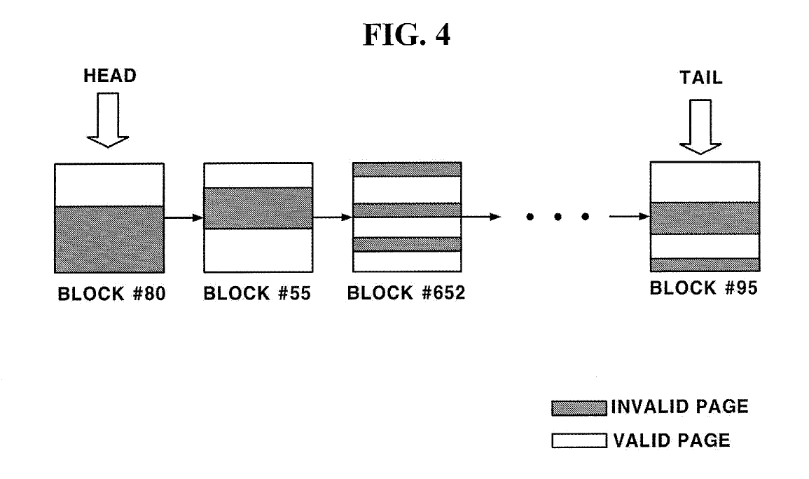

More specifically, the first-block management module 120 may arrange the first blocks in the first block list in the order the invalid pages of the first blocks are generated. For example, if the first block list is as shown in FIG. 4, it may be understood that invalid pages of block #95 have been least recently generated, and that an invalid page of block #80 has been most recently generated. In this case, block #80 may become the head of the first block list and block #95 may become the tail of the first block list. A block at the tail of the first block list, i.e., block #95, may be interpreted to include invalid pages that have been least recently generated. The first block list illustrated in FIG. 4 is an example of a FIFO-based first block list.

If a new invalid page is detected from one of the blocks included in the first block list or from a block not included in the first block list, the first-block management module 120 may update the first block list.

More specifically, referring to FIG. 4, if a new invalid page is detected from a block not included in the first block list, e.g., block #400, the first-block management module 120 may insert block #400 into a head portion of the first block list so that block #400 can become a new head of the first block list.

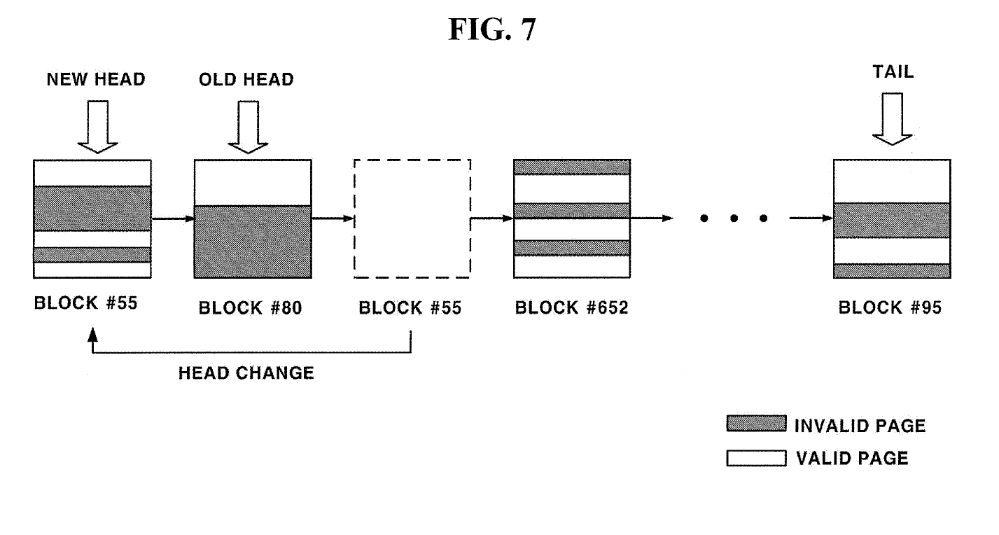

On the other hand, if a new invalid page is detected from block #55 included in the first block list, the first-block management module 120 may modify information regarding block #55. If the first block list is managed in an LRU manner, the first-block management module 120 may update the first block list so that block #55 can become a new head of the first block list, as illustrated in FIG. 7.

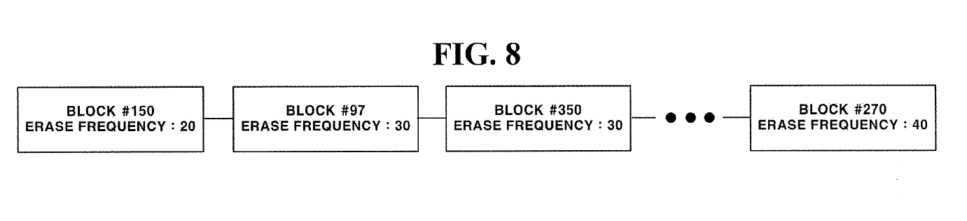

The second-block management module 130 may generate a second block list in order to manage a plurality of second blocks to be allocated for storing data and for performing garbage collection. The second-block management module 130 may arrange the second blocks in the second block list according to count values of the second blocks, for example, according to the number of times each of the second blocks has been erased. More specifically, the second-block management module 130 may arrange the second blocks in the second block list in ascending order of the number of times that each of the second blocks has been erased, as illustrated in FIG. 8. However, the present invention is not restricted to this. That is, the second-block management module 130 may arrange the second blocks in the second block list in descending order of the number of times that each of the second blocks has been erased. In short, the second-block management module 130 may arrange the second blocks in the second block list in either ascending or descending order of the number of times that each of the second blocks has been erased.

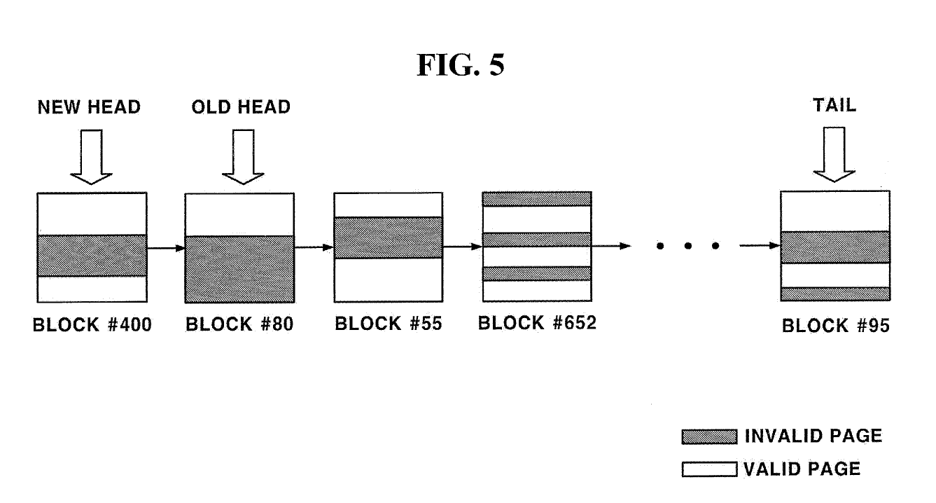

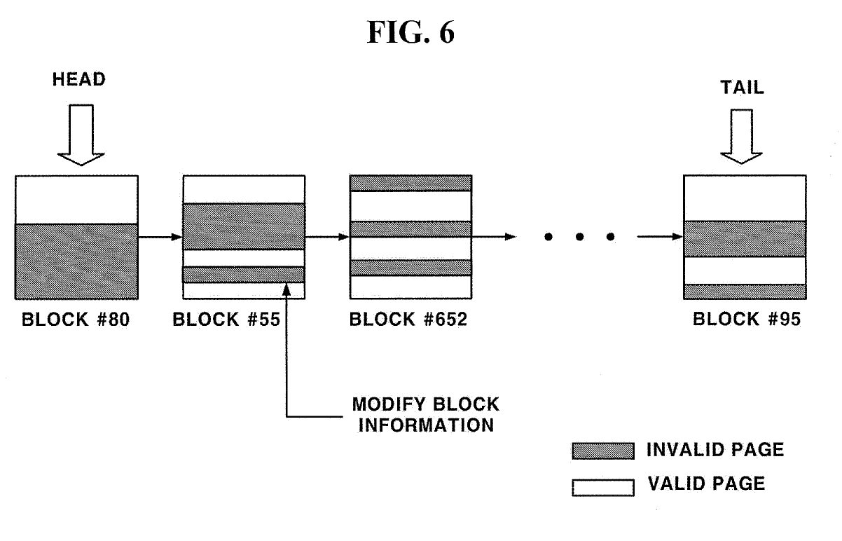

The control module 140 may allocate the second blocks managed by the second-block management module 130 in order to store data or to perform garbage collection. More specifically, in order to store data, the control module 140 may allocate a second block that has been erased the least number of times for the purpose of wear leveling. On the other hand, in order to perform garbage collection, the control module 140 may allocate a second block that has been erased the most number of times to a first block including one or more invalid pages that have been least recently generated. For example, referring to FIGS. 5 and 8, the control module 140 may allocate block #270 that has been erased the most number of times to block #95 including one or more invalid pages that have been least recently generated, in order to store data. On the other hand, in order to perform a typical data write operation, the control module 140 may allocate block #150 that has been erased the least number of times for the purpose of wear leveling.

In order to perform garbage collection, the control module 140 may select a first block including one or more invalid pages that have been least recently generated from the first block list in view of the fact that a first block including the invalid pages that have been least recently generated is unlikely to have been modified. Then, the control module 140 may select a second block that has been erased the most number of times, instead of, for example, a second block that has been erased the least number of times, from the second block list to the selected first block in order to properly perform wear leveling. Thereafter, the control module 140 may allocate the selected second block to the selected first block and may thus be able to properly perform wear leveling since data copied from the selected first block to the selected second block is unlikely to be modified.

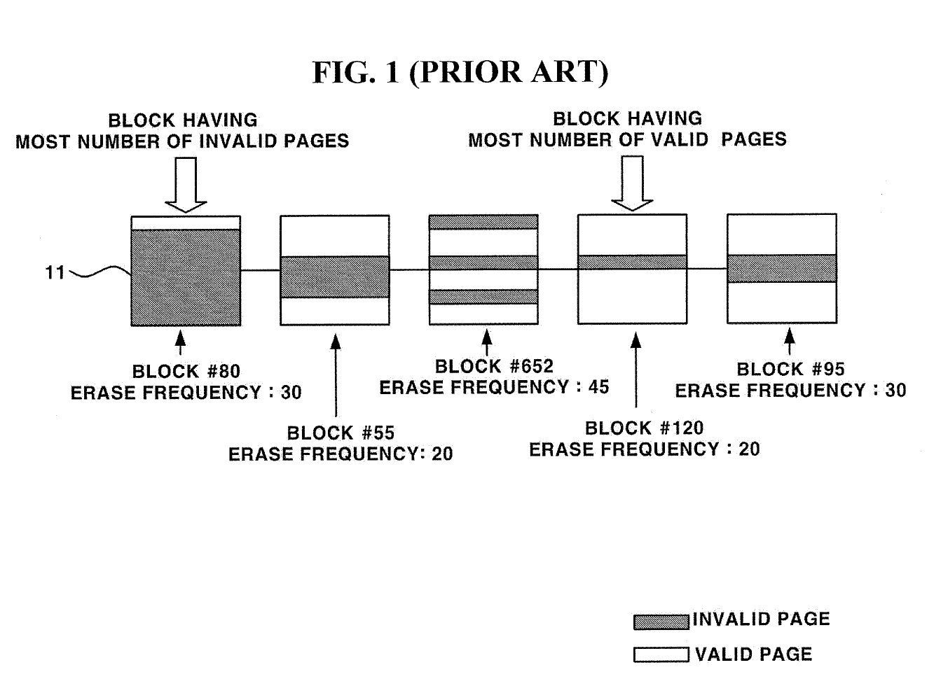

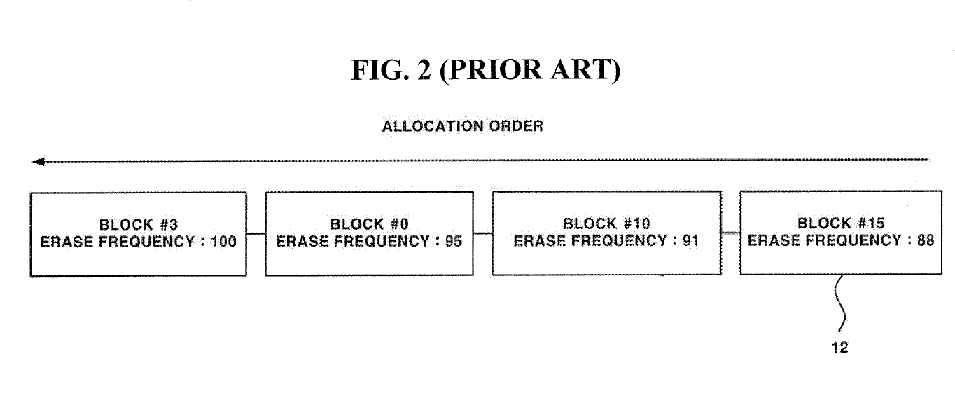

As appreciated by the present inventors, in some the conventional approaches, the attributes of data are not taken into consideration when performing garbage collection. For example, in the approaches illustrated in FIGS. 1 and 2, garbage collection is indiscriminately performed on data regardless of whether the data is ordinary data or metadata, which may be updated more frequently than ordinary data. Therefore, as appreciated by the present inventors, pages including data that is frequently updated may be likely to become invalid, which results may increase the number of invalid pages and the operational overhead of garbage collection.

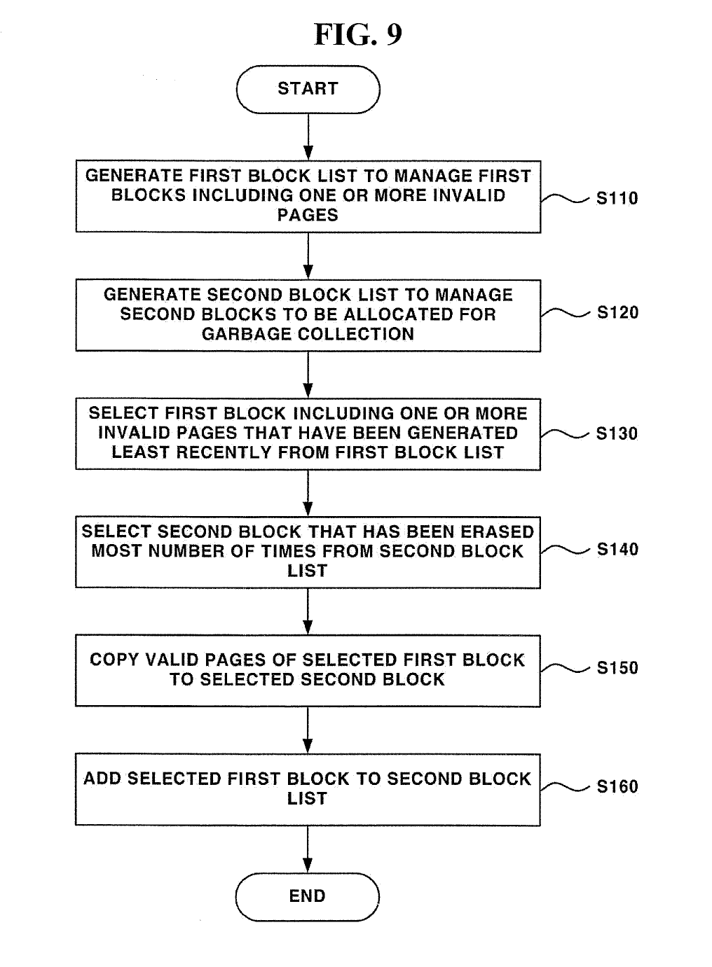

FIG. 9 illustrates a flowchart of a garbage collection method of a nonvolatile memory, according to an embodiment of the present invention. Referring to FIG. 9, the first-block management module 120 generates a first block list to manage a plurality of first blocks of the nonvolatile memory 110 (S110). The first block list may be maintained in a FIFO manner, an LRU manner, or both. Other techniques may also be used.

The second-block management module 130 generates a second block list in order to manage a plurality of second blocks to be allocated for storing data or for performing garbage collection (S120). The second blocks may be arranged in the second block list in the order of the number of times each of the second blocks has been erased.

In order to perform garbage collection, the control module 140 selects a first block including one or more invalid pages that have been least recently generated from the first block list (S130).

Thereafter, the control module 140 selects a second block that has been erased the most number of times from the second block list and allocates the selected second block to the selected first block (S140).

Thereafter, the control module 140 copies one or more valid pages of the selected first block to the selected second block so that no valid pages can be left in the selected first block (S150). Then, the second-block management module 130 adds the selected first block to the second block list (S160).

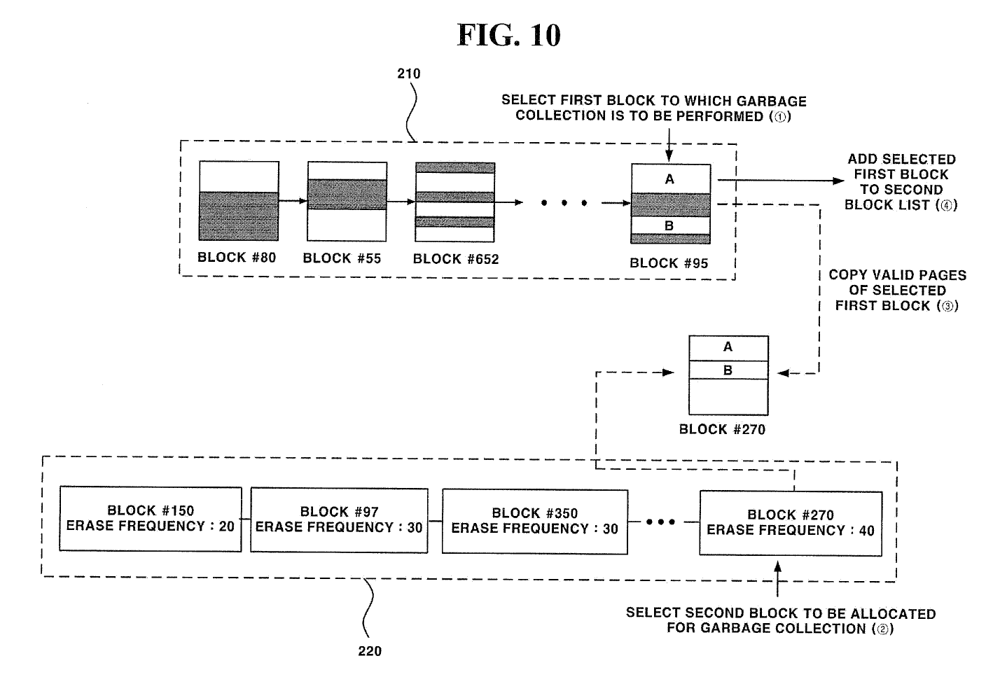

The garbage collection method illustrated in FIG. 9 will hereinafter be described in further detail with reference to FIG. 10.

Referring to FIG. 10, a first block to which garbage collection is to be performed, e.g., block #95, is selected from a first block list 210 (1). Thereafter, a second block to be allocated for performing garbage collection, e.g., block #270, is selected from a second block list 220 (2). Thereafter, one or more valid pages of block #95 are all copied to block #270 so that no valid pages can be left in block #95 (3). Thereafter, block #95 is added to the second block list 220 (4) While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed:

1. A garbage collection apparatus of a nonvolatile memory, the apparatus comprising:
a first-block management module configured to manage a plurality of first blocks, each of the first blocks including at least one respective invalid page of the nonvolatile memory;
a second-block management module configured to manage a plurality of second blocks to be allocated for storing data and/or metadata in the nonvolatile memory and configured to perform garbage collection for the nonvolatile memory; and
a control module configured to allocate ones of the second blocks to respective ones of the first blocks according to when the at least one respective invalid page in each of the first blocks was generated or used.

2. The garbage collection apparatus of claim 1, wherein the first-block management module is configured to generate a first block list including references to the first blocks arranged in a First-In-First-Out (FIFO) order of generation of the invalid pages of the first blocks, and configured to allocate a head pointer to one of the first blocks including one or more invalid pages that have been most recently generated.

3. The garbage collection apparatus of claim 2, wherein the first-block management module is configured to allocate a new head pointer to a first block in the first block list, the first block including a new invalid page, responsive to the new invalid page being generated.

4. The garbage collection apparatus of claim 2, wherein the first-block management module is configured to add a new first block including a new invalid page to a head portion of the first block list responsive to the new invalid page being generated in a first block not previously included in the first block list.

5. The garbage collection apparatus of claim 1, wherein the second-block management module is configured to generate a second block list in which the second blocks are arranged according to an order of a number of times each of the second blocks has been erased.

6. The garbage collection apparatus of claim 5, wherein the control module selects a first block including one or more invalid pages that have been least recently generated from the first block list, selects a second block that has been erased the most number of times from the second block list, and performs garbage collection by allocating the selected second block to the selected first block.

7. The garbage collection apparatus of claim 1 wherein the control module is further configured to transfer valid pages of data included in each of the first blocks to the respective ones of the second blocks.

8. The garbage collection apparatus of claim 1 wherein the control module being configured to allocate based on usage comprises allocating the second blocks based on when each of the second blocks was last used.

9. A method of performing garbage collection in a nonvolatile memory, the method comprising:
managing a plurality of first blocks, each of the first blocks including at least one respective invalid page of the nonvolatile memory;
managing a plurality of second blocks to be allocated for storing data and/or metadata in the nonvolatile memory and performing garbage collection for the nonvolatile memory; and
allocating ones of the second blocks to respective ones of the first blocks according to when the at least one respective invalid page in each of the first blocks was generated or used.

10. The method of claim 9 wherein managing a plurality of first blocks comprises generating a first block list including references to the first blocks arranged in a First-In-First-Out (FIFO) order of generation of the invalid pages of the first blocks; and
allocating a head pointer to one of the first blocks including one or more invalid pages that have been most recently generated.

11. The method of claim 10, wherein managing a plurality of first blocks comprises allocating a new head pointer to a first block in the first block list, the first block including a new invalid page, responsive to the new invalid page being generated.

12. The method of claim 10, wherein managing a plurality of first blocks comprises adding a new first block including a new invalid page to a head portion of the first block list responsive to the new invalid page being generated in a first block not previously included in the first block list.

13. The method of claim 9, wherein managing a plurality of second blocks comprises generating a second block list in which the second blocks are arranged according to an order of a number of times each of the second blocks has been erased.

14. The method of claim 13, wherein the allocating comprises:
selecting a first block including one or more invalid pages that have been least recently generated from the first block list;
selecting a second block that has been erased a most number of times from the second block list;
transferring valid pages of data included in each of the first blocks to the respective ones of the second blocks.

15. The method of claim 9 wherein allocating comprises allocating the second blocks based on when each of the second blocks was last used.

16. A computer program product for performing garbage collection in a nonvolatile memory comprising:
a computer readable medium having computer readable program code embodied therein, the computer readable program product comprising:
computer readable program code configured to manage a plurality of first blocks, each of the first blocks including one or more invalid pages;
computer readable program code configured to manage a plurality of second blocks to be allocated for storing data and metadata and for performing garbage collection, each of the second blocks including invalid pages only; and
computer readable program code configured to allocate the second blocks to the first blocks, respectively, in an order the invalid pages of the first blocks are generated and transferring valid data in each of the first blocks.
